(19) United States
(12) Patent Application Publication
(10) Pub. No.: US 2025/0165511 A1
(43) Pub. Date: May 22, 2025

(54) METHOD OF PROVIDING CHAT SERVICE USING LARGE LANGUAGE MODEL AND CHAT SERVICE SERVER USING SAME

(71) Applicant: SAMSUNG SDS CO., LTD., Seoul (KR)

(72) Inventors: Sundeuk KIM, Seoul (KR); Taedok EOM, Seoul (KR); Kyung Hyuk AN, Seoul (KR); Jungsoo KIM, Seoul (KR); Ho Joon LEE, Seoul (KR); Bill KANG, Seoul (KR); Sunhae JUNG, Seoul (KR); Jiwon SEO, Seoul (KR); Sooyeon PARK, Seoul (KR)

(73) Assignee: SAMSUNG SDS CO., LTD., Seoul (KR)

(21) Appl. No.: 18/933,084

(22) Filed: Oct. 31, 2024

(30) Foreign Application Priority Data
Nov. 21, 2023 (KR) 10-2023-0162648
Nov. 21, 2023 (KR) 10-2023-0162666
Jan. 30, 2024 (KR) 10-2024-0014333
Jan. 30, 2024 (KR) 10-2024-0014370

(51) Int. Cl. G06F 16/332; G06F 9/445

(52) U.S. Cl. CPC G06F 16/3329; G06F 9/44526

(57) ABSTRACT

Disclosed are a chat service providing method that uses a large language model (LLM) and a chat service server using the same. A chat service provision method of a chat service server that uses a large language model according to an embodiment may include an operation of receiving a natural language-based query message from a user, an operation of searching for a target catalog corresponding to the query message from among a plurality of catalogs generated based on data assets, an operation of associating the target catalog with an online workspace assigned to the user, an operation of calling an LLM application that provides an LLM service corresponding to the query message in the workspace, and generating an inference result for the query message based on the target catalog by using the LLM application, and an operation of providing a response message including the inference result to the user.

### CROSS-REFERENCE TO RELATED APPLICATION(S)

This application is based on and claims priority under 35 U.S.C. 119 to Korean Patent Applications No. 10-2023-0162648, filed on Nov. 21, 2023, No. 10-2023-0162666, filed on Nov. 21, 2023, No. 10-2024-0014370, filed on Jan. 30, 2024, and No. 10-2024-0014333, filed on Jan. 30, 2024, in the Korean Intellectual Property Office, the disclosure of which is herein incorporated by reference in its entirety.

### BACKGROUND OF THE INVENTION

### 1. Field of the Invention

The present disclosure relates to a chat service provision method using a large language model and a chat service server using the same, thereby facilitating the utilization of data assets such as applying a natural language conversation scheme to data assets of enterprises or the like so that a user is capable of requesting necessary data via a natural conversation.

### 2. Description of the Related Art

Conventionally, artificial intelligence (AI)—based conversation generation technology is to generate natural responses to user utterance or input sentences by using a large language model (LLM).

In addition, recently, there has been developed a model that generates conversations based on predetermined knowledge by using a Wizard-of-Wikipedia (WOW) bench mark data set including conversation data of two speakers about various topics in Wikipedia documents, or the like. A conversation generation model that has learned from the WOW data set may search for Wikipedia document candidates highly associated with the content recognized from a user input sentence, and may apply a Wikipedia document that is determined as the most suitable one among the candidates when generating a response, thereby outputting a response sentence potentially including the corresponding knowledge.

Recently, there has been cases of applying a large language model or the like to data assets of enterprises or the like for use. However, in this instance, problems such as the exposure of internal information of enterprises or the like, may occur, and the accuracy of response may be decreased due to hallucination or false responses unless the documents that a conversation generation model refers to are limited to a predetermined field.

### SUMMARY

The present disclosure has been made in order to solve the above-mentioned problems in the prior art, and an aspect of the present disclosure is to provide a chat service provision method using a large language model and a chat service server using the same, thereby facilitating the utilization of data assets such as applying a natural language conversation scheme to data assets of enterprises or the like so that a user is capable of requesting necessary data via a natural conversation.

Another aspect of the present disclosure is to provide a chat service provision method using a large language model, which may apply a large language model-based chat service based on each catalog unit generated from data assets, and a chat service server using the same.

Another aspect of the present disclosure is to provide a chat service provision method using a large language model, which makes a single point of contact for permission management based on an individual user's workspace and facilitates permission management associated with each plug-in applied to a chat service, and a chat service server using the same.

Another aspect of the present disclosure is to provide a chat service provision method using a large language model, which provides various LIM services by adding LLM applications using a plug-in scheme, and a chat service server using the same.

Another aspect of the present disclosure is to provide a chat service provision method using a large language model, which implements an LLM application in a catalog form and reuses the same for various tasks, and a chat service server using the same.

In accordance with an aspect of the present disclosure, there is provided a chat service provision method of a chat service server that uses a large language model (LLM), and the method may include an operation receiving a natural language-based query message from a user, an operation of searching for a target catalog corresponding to the query message from among a plurality of catalogs generated based on data assets, an operation of associating the target catalog with an online workspace assigned to the user, an operation of calling an LLM application that provides an LLM service corresponding to the query message in the workspace and generating an inference result for the query message based on the target catalog by using the LLM application, and an operation of providing a response message including the inference result to the user.

Here, the catalog may be generated from entire data assets including at least one of a document, content, an application programmable interface (API), a file, and program code generated in a predetermined group, and may be a unit of an information set shared, distributed, or used in the predetermined group.

Here, the searching operation may provide, as a search result, a corresponding target catalog from among the plurality of catalogs by using user information associated with the user and query information extracted by performing natural language processing on the query message.

Here the associating operation may provide catalog list including a plurality of target catalogs as a search result, and may associate, with the workspace, a target catalog selected by the user from the catalog list.

Here, the association operation may convert the target catalog into a predetermined meta language and may provide the same to the workspace.

Here, the operation of generating the inference may call the LLM application via a chat API, and may transfer the target catalog converted into the meta language of the workspace to the LIM application.

Here, the LLM service may include at least one among natural language conversation (browsing) service, a knowledge-based conversation (retrieval augmented generation (RAG)) service, a data analysis (code interpreter) service, an API integration service, or the like.

Here, the chat service server may add the LLM application capable of being called via a plug-in, and may extend a providable LIM service.

Here, the chat service providing method according to an embodiment of the disclosure may further include an operation of identifying whether the workspace has permission to associate with the target catalog when the target catalog is retrieved.

Here, the operation of identifying may determine whether the target catalog is included in the workspace's permission information stored in a key management system.

Here, the permission information may include a pass ticket (passticket) which is issued for each user or user group, assigned to the workspace, in response to a usage application for each catalog.

Here, if the workspace does not have the permission, the operation of identifying may receive a usage approval request for the target catalog from the user.

The chat service provision method according to an embodiment may further include an operation of associating a target catalog with the workspace of the user if the user selects the target catalog from a catalog list including a plurality of catalogs before the query message is received.

According to an embodiment of the disclosure, to implement the above-mentioned chat service provision method in combination with hardware, a computer program stored in a medium may be implemented.

In accordance with an aspect of the present disclosure, there is provided a chat service server that includes a processor and provides a chat service using a large language model (LLM), wherein the processor is configured to receive a natural language-based query message from a user, search for a target catalog corresponding to the query message from among a plurality of catalogs generated based on data assets, associate the target catalog with an online workspace assigned to the user, call an LLM application that provides an LLM service corresponding to the query message in the workspace and generate an inference result for the query message based on the target catalog by using the LLM application, and provide a response message including the inference result to the user.

Here, the catalog may be generated from the entire data assets including at least one of a document, content, an application programmable interface (API), a file, and program code generated in a predetermined group, and may be a unit of an information set shared, distributed, or used in the predetermined group.

Here, the association operation may convert the target catalog into a predetermined meta language and may provide the same to the workspace.

Here, the processor may add the LLM application capable of being called using a plug-in, and may extend providable LIM services.

Here, when the target catalog is retrieved, the processor may further include an operation of identifying whether the workspace has permission to associate with the target catalog.

Here, the processor may further include an operation of associating the target catalog with the user's workspace when the user selects the target catalog from a catalog list including a plurality of catalogs before the query message is received.

In accordance with an aspect of the present disclosure, there is provided a chat service provision method of a chat service server that uses a large language model (LLM), the method may include an operation of receiving a natural language-based query message from a user, an operation of searching for a target catalog corresponding to the query message from among a plurality of catalogs generated based on data assets, an operation of searching for a target LLM application that provides an LLM service corresponding to the query message from among a plurality of LLM applications that support plug-ins, an operation of associating the target catalog with an online workspace assigned to the user, and adding the target LLM application as a plug-in, an operation of calling the target LLM application in the workspace, and generating an inference result for the query message based on the target catalog by using the target LLM application, and an operation of providing a response message including the inference result to the user.

Here, the LLM application may be generated to provide a corresponding LLM service by combining an LLM model and a predetermined pattern, and the pattern may include at least one of retrieval-augmented generation (RAG), few shot, and chain-of-thought (CoT).

Here, the LLM application may be implemented by generating a meta language that represents a pattern and a logic for providing the LLM service in a GUI-based workflow form, and generating program code based on the meta language.

Here, the operation of searching for the target LLM application may provide a corresponding target LLM application from among the plurality of LLM applications by using user information associated with the user and query information extracted by performing natural language processing on the query message.

Here, the operation of performing addition as a plug-in may provide an application list including a plurality of target LLM applications as a search result, and may add, as the plug-in, the target LLM application selected by the user from the application list.

Here, the LLM application-based chat service provision method according to an embodiment of the disclosure may further include an operation of adding the target LLM application as a plug-in if the user selects the target LLM application from a plug-in list including a plurality of LLM applications before the query message is received.

Here, the chat service server may add the LLM application capable of being called using a plug-in, and may extend providable LLM services.

The chat service provision method according to an embodiment of the disclosure may further include an operation of identifying whether the workspace has permissions for the target catalog and the target LLM application if the target catalog and the target LLM application are retrieved.

Here, the operation of identifying may include an operation of determining whether the target catalog and the target LLM application are included in the workspace's permission information stored in a key management system.

Here, the permission information may include a pass ticket (passticket) which is issued for each user or user group, assigned to the workspace, in response to a usage application for each catalog and each LLM application.

Here, the identifying operation may include an operation of receiving a usage approval request for the target catalog or the target LLM application from the user if the workspace does not have the permission.

According to an embodiment of the disclosure, to implement the above-mentioned chat service provision method in combination with hardware, a computer program stored in a medium may be implemented.

In accordance with an aspect of the present disclosure, there is provided a chat service server that includes a processor and provides a chat service using a large language model (LLM), the processor is configured to perform an operation of receiving a natural language-based query message from a user, an operation of searching for a target catalog corresponding to the query message from among a plurality of catalogs generated based on data assets, an operation of searching for a target LLM application that provides an LLM service corresponding to the query message from among a plurality of LLM applications that support plug-ins, an operation of associating the target catalog with an online workspace assigned to the user, and adding the target LLM application as a plug-in, an operation of calling the target LLM application in the workspace, and generating an inference result for the query message based on the target catalog by using the target LLM application, and an operation of providing a response message including the inference result to the user.

Here, the LLM application may be generated to provide a corresponding LLM service by combining an LLM model and a predetermined pattern, and the pattern may include at least one of retrieval-augmented generation (RAG), few shot, and chain-of-thought (CoT).

Here, the operation of searching for the target LLM application may provide a corresponding target LLM application from among the plurality of LLM applications by using user information associated with the user and query information extracted by performing natural language processing on the query message.

Here, the operation of performing addition as the plug-in may provide an application list including a plurality of target LLM applications as a search result, and may add, as the plug-in, the target LLM application selected by the user from the application list.

Here, the processor may further include an operation of adding the target LLM application as a plug-in if the user selects the target LLM application from a plug-in list including a plurality of LLM applications before the query message is received.

Here, the processor may add the LLM application capable of being called using a plug-in, and may extend providable LLM services.

Here, the processor may further include an operation of identifying whether the workspace has permissions for the target catalog and the target LLM application when the target catalog and the target LLM application are retrieved.

In addition, the technical solutions for the mentioned problems are not the enumeration of the features of the present disclosure. Various features of the present disclosure and their advantages and effects will be understood in detail with reference to the detailed embodiments provided below.

According an embodiment of the present disclosure, a chat service provision method using a large language model and a chat service server using the same may enable a user to easily obtain necessary data or the like from data assets via a natural conversation. That is, the user may utilize data assets conveniently via a chat service, and may perform various tasks or the like using the same.

According to an embodiment of the present disclosure, a chat service provision method using a large language model and a chat service server using the same may apply a large language model-based chat service for each catalog unit generated based on data assets, and thus a user may receive an accurate response associated with the field of interest based on each catalog. In addition, since the large language model is applied based on a catalog unit which is part of the data assets, the amount of information exposed to the large language model or the like may be restricted.

According to an embodiment of the present disclosure, a chat service provision method using a large language model and a chat service server using the same may make a single point of contact for permission management based on a workspace assigned to each user. Therefore, it facilitates permission management for each plug-in applied to a chat service.

According to an embodiment of the present disclosure, a chat service provision method using a large language model and a chat service server using the same may add each LLM application using a plug-in scheme according to a user's task, and thus the user may be provided with chat services tailored to various tasks. In addition, the LLM applications may be reusable via catalogs and thus the efficiency of tasks may be increased.

In this instance, effects that could be achieved by a chat service provision method using a large language model and a chat service server using the same according to embodiments of the disclosure are not limited to the above-described effects, and based on the descriptions provided below, those skilled in the art would clearly understand other effects which are not mentioned.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating a business platform service system according to an embodiment of the present disclosure;

FIG. 2 is a diagram illustrating the structure in which a chat service, a workspace, and a catalog are connected according to an embodiment of the present disclosure;

FIG. 3 is a diagram illustrating extension of LLM services using a plug-in according to an embodiment of the present disclosure;

FIG. 4 is a block diagram illustrating a chat service server according to an embodiment of the present disclosure;

FIG. 5 is a diagram illustrating the structure of a catalog, a workspace, and a chat service according to an embodiment of the present disclosure;

FIG. 6 is a diagram illustrating production of an LIM application according to an embodiment of the present disclosure;

FIG. 7 is a diagram illustrating the operation of a chat service according to an embodiment of the present disclosure;

FIG. 8 is a diagram illustrating the operation of a chat service including permission management according to an embodiment of the present disclosure;

FIG. 9 is a diagram illustrating the operation of a chat service according to another embodiment of the present disclosure;

FIG. 10 is a diagram illustrating the operation of a chat service including permission management according to another embodiment of the present disclosure;

FIG. 11 is a block diagram illustrating a computing device according to an embodiment of the present disclosure;

FIG. 12 is a flowchart illustrating a chat service provision method using an LLM according to an embodiment of the present disclosure; and

FIG. 13 is a flowchart illustrating a chat service provision method using an LLM according to another embodiment of the present disclosure.

### DETAILED DESCRIPTION

Hereinafter, reference will now be made to example embodiments, which are illustrated in the accompanying drawings, wherein like reference numerals may refer to like components throughout and duplicated description thereof will be omitted. An ending word used for a component, such as “module” and “unit”, is assigned or used for ease of drafting the specifications, and may not have a distinguishing meaning or role. In this instance, the term, “unit”, used in embodiments may refer to a software component or a hardware component such as “FPGA” or “ASIC”, and “unit” may perform some functions. However, “unit” is not limited to software or hardware. “Unit” may be configured to be in an addressable storage medium, or may be configured to reproduce one or more processors. Therefore, for example, “unit” may include components, such as software components, object-oriented software components, class components, and task components, processes, functions, attributes, procedures, sub-routines, segments of program code, drivers, firmware, microcode, circuit, data, database, data structures, tables, arrays, and variables. A function provided in the components and “units” may be implemented by coupling the functions of a smaller number of components and “units” or may be implemented by separating the function to additional components and “units”.

In addition, when it is determined that detailed descriptions related to a well-known related technical art make the subject matter of the embodiments disclosed in the specification unclear, the detailed descriptions will be omitted herein. In addition, the attached drawings are merely to help understanding of embodiments disclosed in the specification, and it should be understood that the attached drawings do not limit the technical idea disclosed in the specification, but to the contrary, it should be construed that all modifications, equivalents, and alternatives falling within the scope of the idea and technology of the present disclosure are included.

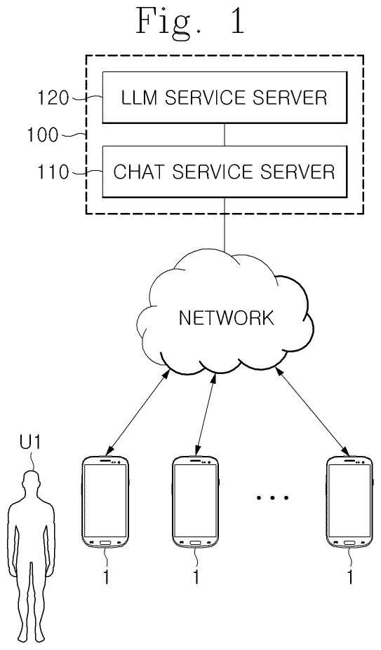

FIG. 1 is a diagram illustrating a business platform service system according to an embodiment of the disclosure.

Referring to FIG. 1, a business platform service system according to an embodiment of the present disclosure may include a terminal device 1 and a service server 100, and the service server 100 may include a chat service server 110 and an LLM service server 120.

Hereinafter, a business platform service system according to an embodiment of the present disclosure will be described with reference to FIG. 1.

The terminal device 1 may perform communication with the service server 100 or the like using a wired or wireless communication network. The terminal device 1 may perform data communication with the service server 100, and the terminal device 1 may be equipped with a communication module for information transmission or reception, a memory for storing a program and a protocol, a processor for executing various programs to perform operations and control, or the like.

Specifically, the terminal device 1 may be a mobile terminal such as a smartphone, a tablet PC, or the like, and a stationary device such as a desktop or the like may be included in the terminal device 1. For example, the terminal device 1 may include portable phones, smartphones, laptop computers, digital broadcasting terminals, personal digital assistants (PDA), portable multimedia players (PMP), slate PC, a tablet PC, an ultrabook, a wearable device (e.g., a smartwatch, smart glasses, a head mounted display (HMD)), or the like.

The communication network may include a wired network and a wireless network, and may include various networks, specifically, a local area network (LAN), a metropolitan area network (MAN), a wide area network (WAN), or the like. In addition, the communication network may include World Wide Web (WWW) which is a publicly known network. In this instance, the communication network according to the present disclosure is not limited to the above-mentioned network, and may include a publicly known wireless data network, a publicly known telephone network, a publicly known wired or wireless television network, or the like.

The service server 100 may be connected to the terminal device 1 and may provide various business platform services. The service server 100 may be operated by a predetermined group such as an enterprise, school, research institution, association, or the like, and may provide a portal service by integrating various services related to business operated by the corresponding predetermined group. Here, the predetermined group may include a group temporarily gathered for a predetermined project.

The service server 100 may provide, to each user or user group, a workspace which is a space on the Web for tasks, and a user may register necessary documents, applications or the like to the user's workspace and may perform tasks. A workspace may be assigned for each individual user or user group (e.g., a department or team).

In addition, the service server 100 may include catalogs generated based on data assets such as data, software, applications or the like that a predetermined group retains, and a user may perform tasks by associating the catalogs with the user's workspace.

Here, a catalog is a unit of an information set generated based on the entire data assets generated by a predetermined group, and each catalog may be shared, distributed, used within the predetermined group. For example, to perform personnel management that is a user's task in one enterprise, the user may selectively collect necessary documents, contents, program codes or the like, and may generate a personnel management catalog including the collected data assets. Subsequently, the corresponding user may share the personnel management catalog within the enterprise so that another user is capable of referring to the corresponding personnel management catalog when performing similar tasks or the like. That is, a production that is generated in a form required for processing an individual task by selecting and processing data assets may be a catalog.

Catalogs may be classified as a plurality of categories, for example, a data catalog including data generated within a predetermined group, an application catalog including various applications that the predetermined group retains, an asset catalog including contents, programs, or the like produced by the predetermined group, a knowledge catalog including the predetermined group's internal rules, guidelines, produced documents, or the like, a connector catalog including an application program interface or the like generated by the predetermined group, or the like. In this instance, the classification is not limited thereto, catalogs may be classified in various manners according to embodiments.

In addition, producers such as data or system experts may produce and supply catalogs based on data assets, and users (U1) may search for catalogs required for the users' tasks among a plurality of catalogs included in the service server 100 for use. That is, the service server 100 may provide a marketplace that provides catalogs produced by producers to users (U1).

The service server 100 may provide a chat service using the chat service server 110. In this instance, the chat service may enable conversation with a large language model (LLM)-based artificial intelligence (AI). The chat service may include a messenger service that supports conversation between users (U1), but, herein, it is described based on a chat service that provides conversation with an LLM-based AI.

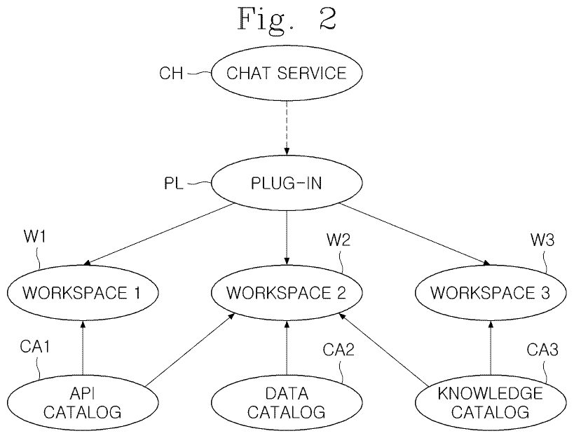

Specifically, when providing a chat service, the chat service server 110 may generate a response by associating a catalog with an individual user's workspace. That is, as illustrated in FIG. 2, for provision of a chat service (CH), a plug-in (PL) provided by each chat service (CH) may be selected. Here, a plug-in may be an LLM application provided by the LLM service server 120. That is, based on a plug-in (PL) connected to each chat service, an LLM service provided by the corresponding chat service (CH) may be determined. Here, LIM applications may include a natural language conversation (browsing) service, a knowledge-based conversation (retrieval augmented generation (RAG)) service, a data analysis (code interpreter) service, an API integration service, or the like. In addition, according to a necessary function, a user may select and add various plug-ins (PLs). In this instance, since a natural language conversation service that generates a natural language response corresponding to an input query message may be a function needed for the entire chat service (CH), a plug-in (PL) corresponding to the natural language conversation service may be included by default.

Subsequently, a corresponding catalog (CA1, CA2, CA3) may be selected according to a user's request, and each catalog (CA1, CA2, CA3) may be associated with an individual user's workspace (W1, W2, W3). That is, a chat service (CH) may be capable of generating a response based on each corresponding catalog (CA1, CA2, CA3) and providing the same to the individual user's workspace (W1, W2, W3) in response to the user's query.

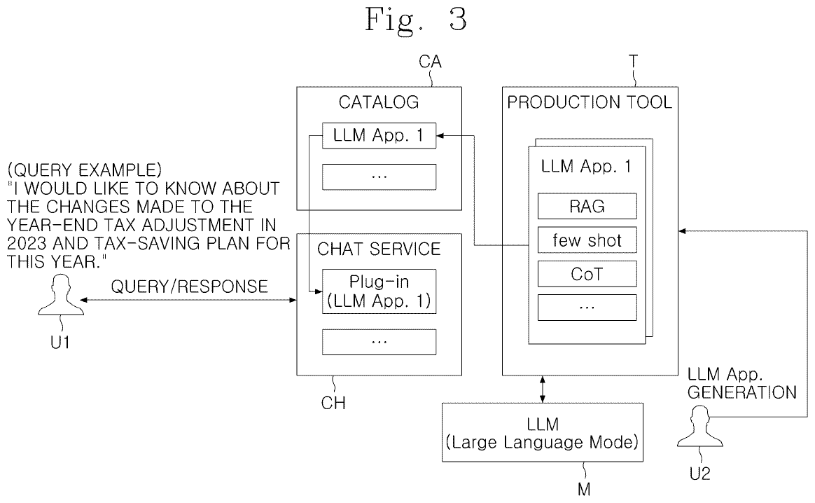

Here, referring to FIG. 3, a producer (U2) may produce various LLM applications by using a production tool (T), and the produced LLM applications may be provided in the forms of catalogs (CA). That is, each LLM application produced in the form of a catalog (CA) may be added to a chat service (CH) using a plug-in scheme, and may derive an inference result for the query message of a user (U1) so that the chat service (CH) may produce an appropriate response message.

For example, the producer (U2) may produce in advance and register an LLM application (LLM App. 1) that provides various information associated with a year-end tax adjustment or the like in a conversation form since the year-end tax adjustment tasks needs to be performed at the beginning of every year. Subsequently, if the user (U1) inputs a query message such as “I would like to know about the changes made to the year-end tax adjustment in 2023 and tax-saving plan”, the chat service (CH) may search for the corresponding LLM application (LLM App. 1) and add the same as a plug-in. In this instance, the corresponding LLM application (LLM App. 1) may derive an inference result appropriate for the query message of the user (U1) and may provide the same as response message.

Here, each LLM application may not be dependent upon an LLM model (M) or chat service (CH) used. That is, although an LLM model or chat service (CH) is changed, a corresponding LLM service may be capable of being provided by using the same LLM application. In addition, if an LLM application is cataloged as illustrated in FIG. 3, reusability of the corresponding LLM application may be secured, and permission control for each LLM application may be performed in the same manner as a catalog.

Each LLM application may be produced to provide a corresponding LLM service by combining a predetermined pattern and an LLM model. Here, the predetermined pattern may include a retrieval-augmented generation (RAG), few shot, chain-of-thought (CoT), or the like. RAG corresponds to a pattern that searches for external information and generates a response based on a search result, and few shot corresponds to a pattern that sends several examples to refer to in association with the query message that the user inputs. In addition, CoT corresponds to a pattern that increases a correct answer rate by further including an instruction that induces an LLM model to perform steps of inference. That is, each LLM application may include a pattern such as RAG, few shot, CoT, or the like, and the type, the period of use, the order of use, or the like of each pattern may be configured to be different for each LLM application.

Generally, when an LLM model is applied to a chat service, problems such as the exposure of the internal data of enterprises or the like to the outside may occur. In addition, since the scope of an LLM model is not limited to a specific field that a user is interested in, the accuracy of a response may be decreased due to hallucination, false responses, or the like, which is also a drawback.

Conversely, the chat service server 110 according to an embodiment of the present disclosure may perform permission management based on each user's workspace, and thus may prevent the internal data from being exposed to entities having no permission. In addition, data assets are divided into catalogs and thus, the amount of information provided to an LLM may be limited, and accurate responses in association with the fields of interest of users may be provided based on the catalogs.

In addition, the chat service server 110 according to an embodiment of the present disclosure may support a plug-in of an LLM application that is independent from a chat service or an LLM mode, and thus may facilitate the extension of LLM services provided by the chat service and the increase of the efficiency of tasks of a user (U1).

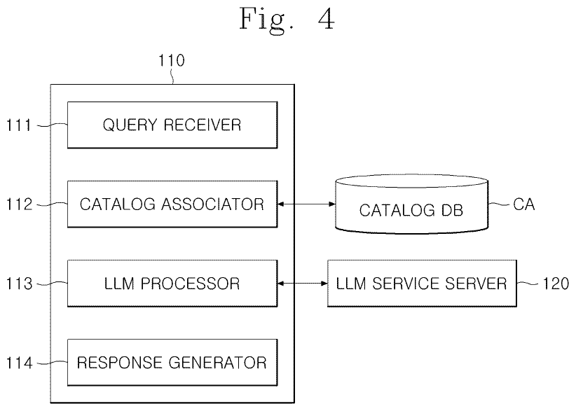

Referring to FIG. 1, the service server 100 may include the chat service server 100 and the LLM service server 120, and the chat service server 110 may provide an LLM-based chat service, and the LLM service server 120 may provide an LLM application that runs a plug-in required for a chat service. Here, the chat service server 110 and the LLM service server 120 may be implemented as an entity integrated with the service server 100, or may be implemented separately. Hereinafter, the chat service server 110 according to an embodiment of the present disclosure is described with reference to FIG. 4.

FIG. 4 is a block diagram illustrating the chat service server 110 according to an embodiment of the present disclosure.

Referring to FIG. 4, the chat service server 110 according to an embodiment of the present disclosure may include a query receiver 111, a catalog associator 112, an LLM processor 113, and a response generator 114.

The query receiver 111 may receive a natural language-based query message from a user (U1). The user may input a necessary query message via a chat application (not illustrated) or the like, and the query message may be input in the form of text, voice, or the like. In addition, various types of attached files such as images, voice, videos, program codes, or the like may be included and transmitted together.

According to an embodiment, a chat application may be provided in a portal page provided by the service server 100, and a user may access the portal page using the user's terminal device 1 and may input a query message or the like via the chat application provided by the portal page.

The catalog associator 112 may search for a target catalog corresponding to the query message from among a plurality of catalogs generated based on data assets, and may associate the retrieved target catalog with the workspace of a user U1. That is, when a query message is input, the catalog associator 112 may search a catalog DB (CA) for a target catalog which is a basis for generation of a response message for the corresponding query message, and may associate the retrieved target catalog with the workspace of the corresponding user (U1) so as to enable the user (U1) to perform a task based on the target catalog on the corresponding workspace.

Specifically, the catalog associator 112 may be provided with user information associated with the corresponding user (U1) from the service server 100 or the like, and may extract query information included in the query message via a natural language process (NLP). Subsequently, based on the user information and query information, corresponding target catalogs from among the plurality of catalogs may be provided as a search result. User information may include contents associated with a department, position, duty, or the like for each user (U1), and query information may be an embedding vector extracted from a query message by using a neural network model or the like.

According to an embodiment, the catalog associator 112 may provide a catalog list including a plurality of target catalogs as a search result, and a user (U1) may select any one target catalog from the catalog list. In this instance, the catalog associator 112 may associate the target catalog selected by the user with a workspace. In this instance, the catalog associator 112 may perform the association in a manner of converting the target catalog into a predetermined meta language such as JSON or the like and providing the same to the workspace, or the like.

According to an embodiment, although a query message is not input yet, the catalog associator 112 may associate a target catalog with a user (U1)'s workspace in response to a request from the corresponding user (U1). That is, the user (U1) may search for a catalog corresponding to a task to perform before working on the task, and may request the association of the retrieved target catalog with the user's workspace. In this instance, the catalog associator 112 may perform searching and provide a list of retrieved catalogs in response to the request from the user, and may associate, with the workspace of the corresponding user (U1), a target catalog selected by the user (U1) from the list. There may be other embodiments where the catalog associator 112 provides a list of recommended catalogs before a user (U1) performs searching, and the user (U1) selects a target catalog from the corresponding recommended list.

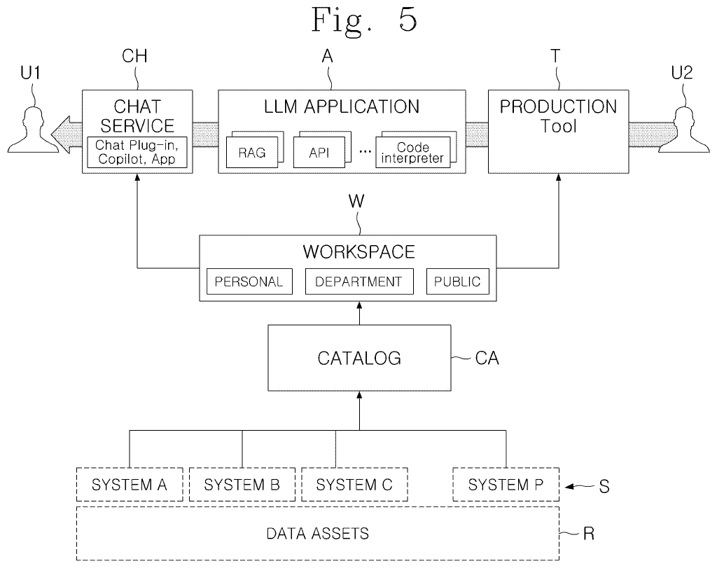

Subsequently, when the target catalog is retrieved, the catalog associator 112 may identify whether the workspace has permission to associate with the target catalog. Referring to FIG. 5, data assets (R) in a predetermined group may be managed separately by a plurality of systems(S), and the systems(S) may have different permission management systems. As described above, in the case in which each system (S) has a different permission management system, an integrated permission management system needs to be developed first by analyzing the permission system of an individual system(S), and needs to be applied to an LLM application (A), in order to develop the LLM application (A) or the like.

That is, the LLM application (A) may utilize data assets (R), and thus, to satisfy the security standard of the predetermined group or the like, access permission or the like for each data asset (R) needs to be identified and operations related thereto need to be performed. To this end, an integrated permission management system that integrates and manages permission management systems of the systems(S) needs to be developed for the data assets (R) used by the corresponding LLM application (A). However, considering time and costs, there may be practical challenges to developing a new integrated permission management system by integrating permission management systems that have been established in various systems(S).

Herein, a workspace (W) and a catalog (CA) may be utilized to overcome the challenges. That is, permission management may be performed by loading the data assets (R) to catalogs (CA), and utilizing a workspace (W) that assigns permissions collectively or adjusts permissions. In this instance, each LIM application (A) may not need to apply the permission system of each system(S), and respective permissions may be identified collectively and processed in the workspace (W). As described above, it enables a single point of contact for permission management based on a workspace (W), whereby permission management may be effectively performed. That is, the catalog associator 112 may identify permissions of each workspace (W), and may determine whether the corresponding workspace (W) has access permission for an individual catalog (CA).

According to an embodiment, the catalog associator 112 may identify whether permission for the corresponding target catalog is included based on workspace's permission information stored in a key management system (not illustrated) of the service server 100. Here, the permission information may be a pass ticket (passticket) issued for each user or user group assigned to a workspace in response to a usage application for each catalog. The pass ticket may be issued by a producer (U2) that produces a catalog or an LLM application (A), or by a separate permission management system (not illustrated).

That is, each user or user group may apply for the use of an individual catalog, and a pass ticket may be issued upon approval of each usage application. When a pass ticket is issued, a key management system may store the pass ticket as permission information for each workspace. In the case in which a workspace requests the association with a target catalog, the permission of the corresponding workspace may be identified based on the pass tickets stored in the key management system. Subsequently, based on a result of permission identification, whether to associate the target catalog and the corresponding workspace may be determined.

According to an embodiment, when permission for the corresponding target catalog does not exist in the workspace, the catalog associator 112 may display, to a user, a popup message or the like to identify whether the user is to request usage approval. That is, based on an input that the user applies to the popup message, the catalog associator 112 may receive a usage approval request associated with a target catalog. Subsequently, the catalog associator 112 may transmit the usage approval request to a permission management system (not illustrated) or the like, and may request issuing a pass ticket for the corresponding workspace.

The LLM processor 113 may call an LLM application that provides an LIM service corresponding to a query message in a workspace. Here, a plurality of LLM applications that support plug-ins may exist, and the LLM processor 113 may search for a target LLM application that provides an LLM service corresponding to a query message from among the plurality of LLM applications. Subsequently, the target LLM application may be called in the workspace, and the LLM processor 113 may generate an inference result for the query message input by the user (U1), based on a target catalog using the target LLM application.

Specifically, when a query message is input, the LLM processor 113 may search the LLM service server 120 for an LLM application for generating a response message for the corresponding query message. According to an embodiment, an LLM application may be generated as a catalog. In this instance, each LLM application may be retrieved from catalogs.

The LLM processor 113 may be provided with user information associated with the corresponding user (U1) from the service server 100 or the like, and may extract query information included in the query message via a natural language process (NLP). That is, based on the user information and query information, corresponding target LLM applications from among the plurality of LLM applications may be provided as a search result. User information may include contents associated with a department, position, duty, or the like for each user (U1), and query information may be an embedding vector extracted from a query message by using a neural network model or the like.

According to an embodiment, the LLM processor 113 may provide an application list including a plurality of target LLM applications as a search result, and the user (U1) may select any one target LLM application from the application list. In this instance, the LLM processor 113 may plug in the LLM application, selected by the user, to a chat service.

In addition, according to an embodiment, although a query message is not input yet, the LLM processor 113 may plug in an LLM application to a chat service in response to a request from a user (U1). That is, the user (U1) may search for LLM applications corresponding to a task to perform before working on the task, and may request plugging in a retrieved target LIM application. In this instance, the LLM processor 113 may perform searching and provide a list of retrieved LLM applications in response to the request from the user, and may plug in a target LLM application selected by the user (U1) from the list. There may be other embodiments where the LLM processor 113 provides a list of recommended applications before user (U1) performs searching, and the user (U1) selects a target LLM application from the corresponding recommended list.

An inference result for a query message input by a user (U1) may be generated simply using a natural language processing scheme, but there may be a case where an inference result needs to be generated based on various LIM applications. For example, it may be performed via natural language processing such as browsing or the like in the case of a casual conversation. However, in the case of a knowledge-based conversation (RAG) or the like that provides solutions to questions based on the knowledge of a predetermined field, a predetermined LLM application needs to be utilized to generate an appropriate inference result.

Here, various LLM applications or the like may be implemented in the LLM service server 120, and the LLM processor 113 may call each LLM application corresponding to a query message via the LLM service server 120. Specifically, the LLM processor 113 may call a corresponding target LLM application by using a predetermined chat API, and may transfer a target catalog converted into a meta language of a workspace to the called target LLM application by using the chat API. That is, the target LLM application may generate a corresponding inference result based on the corresponding catalog.

Here, LLM services may include a natural language conversation service, a knowledge-based conversation service, a data analysis service, an API integration service, or the like. The natural language conversation service may be a service that provides a casual natural language conversation, generating, as an inference result, a response to a query by taking into account a multi-turn conversation history. The knowledge-based conversation (RAG) service may search for information based on a knowledge catalog selected by a user, and may generate a response including the retrieved information as an inference result. The data analysis service may analyze data based on a data catalog selected by a user. For example, the service may generate and execute a program for data analysis by using Python code or the like, may generate an analysis result graph or the like, and may provide the same as an inference result. The API integration service may execute an API based on a connector catalog selected by a user, and may provide an execution result associated with the corresponding API as an inference result.

Here, each LLM application may be added to a chat service in the form of a plug-in, and the LIM services provided by the chat service may be extended by further including an LLM application capable of being called using a plug-in. According to an embodiment, the natural language conversation service, knowledge-based conversation service, and data analysis service may be connected to the chat service by default for provision, and other remaining LLM applications may be added using plug-ins.

Each LLM application may call an LLM model and request inference according to a flow defined therein, may receive an inference result from the LLM model, and may provide the same to the LLM processor 113. Here, examples of the LLM model may include Llama, OpenBuddy, Azure OpenAI, or the like, and various other LLM models may be utilized. In addition, here, it is not that only a single LLM model is used, but a different LLM model may be used for each LLM application to generate an inference result.

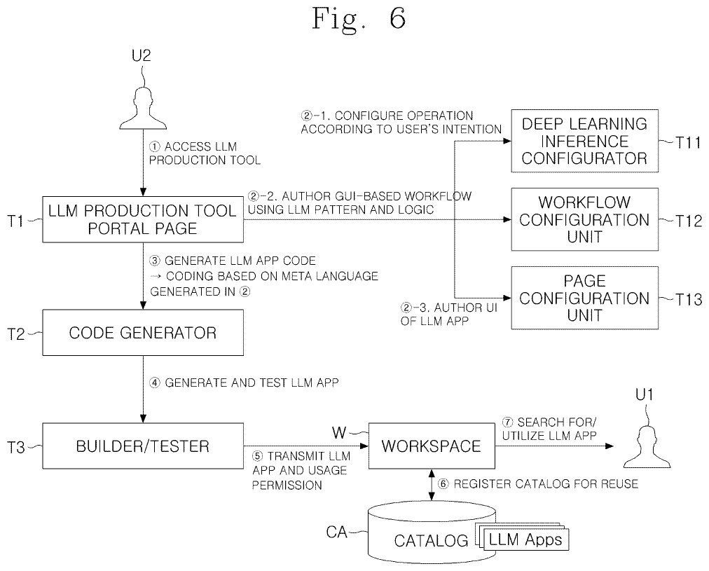

In addition, referring to FIG. 6, an LLM application may be generated by a producer (U2) by using a production tool (T). Specifically, the producer (U2) may access an LLM production tool portal page (T1), and the LLM production tool portal page (T1) may include a deep learning inference configurator (T11), a workflow configuration unit (T12) and a page configuration unit (T13).

Here, the deep learning inference configurator (T11) may define and configure operations required for providing an LLM service that the producer (U2) intends. The workflow configuration unit (T13) may author each pattern and logic in a workflow form by using a graphic user interface (GUI), so that the deep learning inference configurator (T11) performs each defined operation. That is, the producer (U2) may produce and dispose a pattern and a logic included in the corresponding LLM application, and may produce a workflow for an LLM service. The page configuration unit (T14) generates a UI needed for the corresponding LLM application. For example, it generates the UI by disposing each UI component in a drag and drop manner or the like. That is, the producer (U2) may define each operation in the LLM service via the LLM production tool portal page (T1), may produce a workflow by configuring a pattern or a logic to perform the operation, and may produce a UI which a user (U1) in the LLM application is capable of interacting with. Here, finally, the LLM production tool portal page (T1) may provide the corresponding LLM application in the form of a meta language. That is, the producer (U2) may produce an LLM application intuitively and conveniently by using the LLM production tool portal page (T1).

Subsequently, a code generator (T3) may make the LLM application written in the meta language into program code. That is, the code generator (T3) may be a cross compiler and may generate corresponding program code from the meta language. A builder/tester (T4) may perform building and testing on the program code of the LLM application, and the LLM application may be finally produced from the builder/tester (T4). Usage permission or the like may be additionally configured, and the produced LLM application may be provided to a workspace. Here, permission configuration or the like with respect to LLM applications may be performed in the same manner as catalogs, and permission configuration with respect to catalogs has been described in advance and a detailed description thereof will be omitted.

The LLM application may be plugged in to a chat service in the workspace and may provide a corresponding LLM service, and may be registered and stored as a catalog for reuse in the future. Therefore, the user (U1) may search catalogs (CA) for an LLM application that provides a necessary LLM service, and may plug in the same to a chat service for use.

A response generator 114 may provide a response message including an inference result to the user. The response generator 114 may generate a natural language-based response message, and the response message may be generated in the form of text, voice, or the like. According to an embodiment, the response message may be generated and provided in a form that corresponds to a query message from a user (U1). In addition, the response generator 114 may refine text included in the response message for enhanced visibility for the user (U1), and may write and include html, a table, a chart, or the like indicating an inference result in the response message. In this instance, the response message may be displayed in a dialog window of a chat application (not illustrated) into which the user inputs the query message.

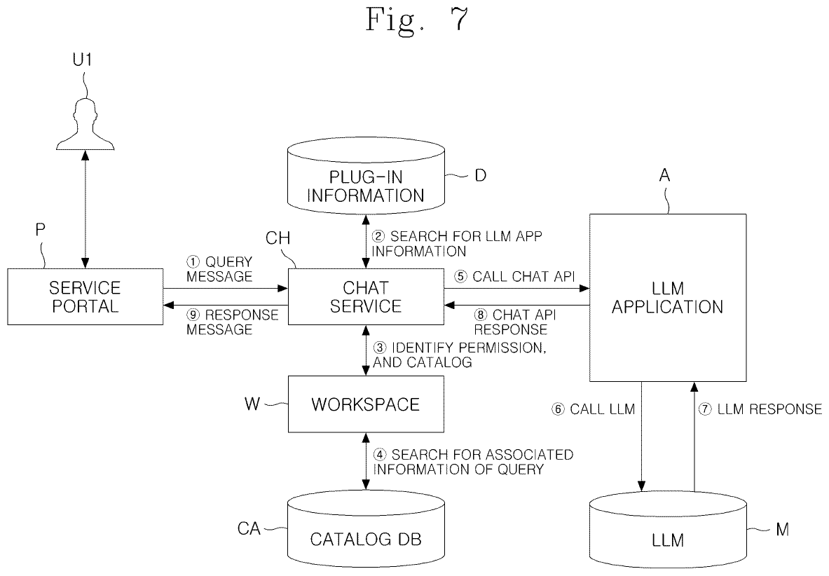

FIG. 7 is a diagram illustrating the operation of a chat service according to an embodiment of the present disclosure. Referring to FIG. 7, a user (U1) may access a service portal (P) of the service server 100. Here, the service portal (P) may be intended to provide a business platform service that supports the user (U1) to handle tasks.

The user (U1) may input a query message via a chat service (CH) provided by the service portal (P). In this instance, the chat service (CH) may search a plug-in DB (D) for information of an LLM application in order to process a query message, and may search for a target catalog for processing the query message.

The chat service (CH) may identify permission of a workspace (W) assigned to the corresponding user (U1), and may determine whether to associate with a target catalog (CA). When the workspace (W) has permission for the target catalog (CA), the chat service (CH) may search for the associated information of the query message of the user (U1) from the target catalog (CA).

Subsequently, the chat service (CH) may call a necessary LLM application (A) from the LLM service server 120 by using a chat API, and the LLM application (A) may call an LLM model (M) and may receive a corresponding LLM response as an inference result.

The LLM application (A) may provide the inference result to the chat service (CH) by using the chat API, and the chat service may generate a response message including the inference result and stream the same to the service portal (P). Therefore, the user (U1) may receive the response message corresponding to the query message via the chat service (CH) provided by the service portal (P).

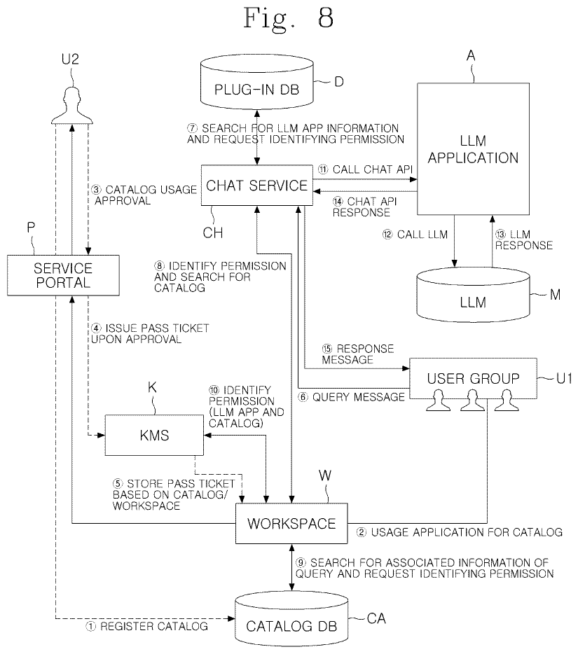

In addition, FIG. 8 is a diagram illustrating the operation of a chat service including permission management according to an embodiment of the present disclosure. Referring to FIG. 8, a producer (U2) that produces a catalog may produce a catalog via a service portal (P), and may register the produced catalog to a catalog DB (CA).

Subsequently, a user or a user group (U1) may apply for the use of the corresponding catalog on its workspace (W), and the service portal (P) may receive, from the producer (U2), a usage approval for the corresponding usage application. Here, although it is illustrated that the producer (U2) approves usage, a separate permission management system (not illustrated) or the like, other than the producer (U2), may determine whether to approve the usage application or the like according to an embodiment.

When the corresponding usage application is approved, the service portal (P) may issue a pass ticket (passticket), and the generated pass ticket may be stored in a key management system (K). Here, the pass ticket may be stored for each catalog or for each workspace.

Subsequently, when the user group U1 inputs a query message, a chat service (CH) may search a plug-in DB (D) for an LLM application required for generating a response to the query message. In addition, it searches for a target catalog and identifies whether the workspace (W) has permission for the target catalog. In this instance, the workspace (W) may request the key management system (K) to identify the permission of the corresponding workspace for the target catalog, and the key management system (K) may identify the permission based on the stored pass tickets and reply. When the corresponding workspace (W) has the permission for the target catalog, it may search for the associated information of the query message from the target catalog and may obtain the same.

Subsequently, the chat service (CH) may call an LLM application (A) using a chat API, and may provide the associated information retrieved from the target catalog to the LLM application (A). The LLM application (A) may call an LLM model (M) according to a defiled flow, may receive an inference result as an LLM response, and may provide the inference result to the chat service (CH) via the chat API. Subsequently, the chat service (CH) may generate a response message including the inference result and may provide the same to the user or user group (U1).

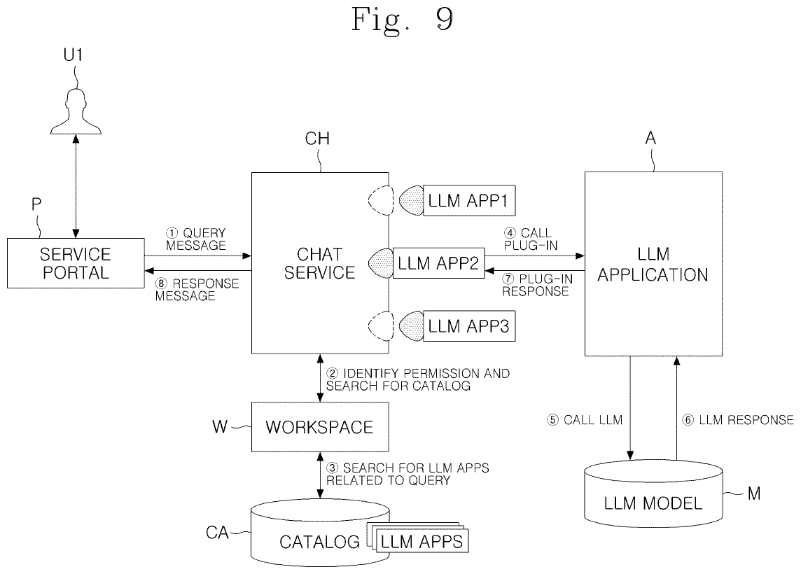

FIG. 9 is a diagram illustrating the operation of a chat service according to another embodiment of the present disclosure. Referring to FIG. 9, a user (U1) may access a service portal (P) of the service server 100. Here, the service portal (P) may be intended to provide a business platform service that supports the user (U1) to handle tasks.

The user (U1) may input a query message via a chat service (CH) provided by the service portal (P). In this instance, the chat service (CH) may respectively search for a target LLM application and a target catalog for processing the query message. Here, the LLM application may be cataloged and stored.

Subsequently, the chat service (CH) may determine whether a workspace (W) assigned to the corresponding user (U1) has permissions for the target catalog (CA) and the target LLM application. Here, when the workspace (W) has permissions for the target catalog (CA) and the target LLM application, it may search a target catalog (CA) for the associated information of the query message and may plug in the target LLM application to the chat service (CH). That is, the chat service (CH) may call and plug in the target LLM application (A) using a chat API, and the LLM application (A) may call an LLM model (M) according to a flow and obtain an LLM response corresponding to the query message as an inference result.

Subsequently, the LLM application (A) may provide the inference result to the chat service (CH) using the chat API, and the chat service may generate a response message including the inference result and stream the same to the service portal (P). Therefore, the user (U1) may receive the response message corresponding to the query message via the chat service (CH) provided by the service portal (P).

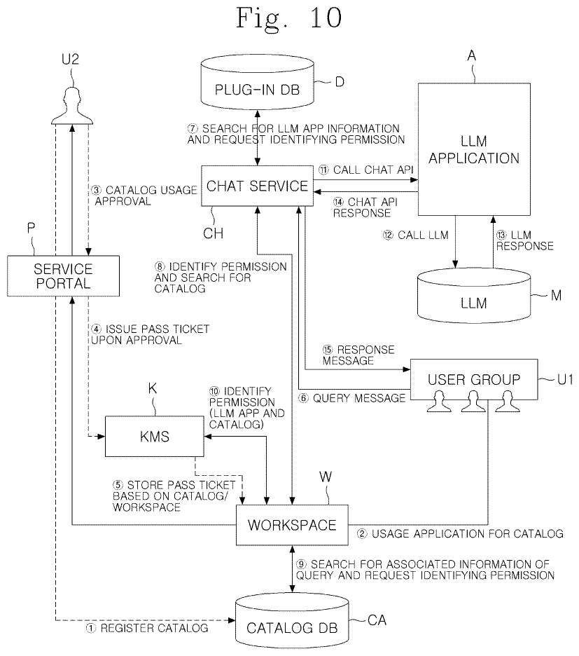

FIG. 10 is a diagram illustrating the operation of a chat service including permission management according to another embodiment of the present disclosure. Referring to FIG. 10, a producer (U2) may produce a catalog or an LLM application via a service portal (P), and may register the produced catalog or LLM application to a catalog DB (CA).

Subsequently, a user or a user group (U1) may apply for the use of the corresponding catalog or LLM application on its workspace (W), and the service portal (P) may receive, from the producer (U2), a usage approval for the corresponding usage application. Here, although it is illustrated that the producer (U2) determines whether to approve usage, a separate permission management system (not illustrated) or the like, other than the producer (U2), may determine whether to approve the usage application or the like according to an embodiment.

When the corresponding usage application is approved, the service portal (P) may issue a pass ticket (passticket), and the generated pass ticket may be stored in a key management system (K). Here, the pass ticket may be stored for each catalog or LLM application, and may be stored for each workspace according to an embodiment.

Subsequently, when the user group (U1) inputs a query message, a chat service (CH) may search a plug-in DB (D) or a catalog DB (CA) for a target LLM application and a target catalog, which are required for generating a response to the query message.

In addition, the chat service (CH) may identify whether the workspace (W) has permissions for the target catalog and the target LLM application. In this instance, the workspace (W) may request the key management system (K) to identify the permissions of the corresponding workspace for the target catalog and the target LLM application, and the key management system (K) may identify the permissions based on the stored pass tickets and reply. When the corresponding workspace (W) has the permissions for the target catalog and the target LLM application, it may plug in the target LLM application to the chat service and may search the target catalog for the associated information of the query message.

Subsequently, the chat service (CH) may call a target LLM application (A) using a chat API, and may provide the associated information retrieved from the target catalog to the target LLM application (A). The target LLM application (A) may call an LLM model (M) according to a defiled flow, may receive an inference result as an LLM response, and may provide the inference result to the chat service (CH) via the chat API. Subsequently, the chat service (CH) may generate a response message including the inference result and may provide the same to the user or user group (U1).

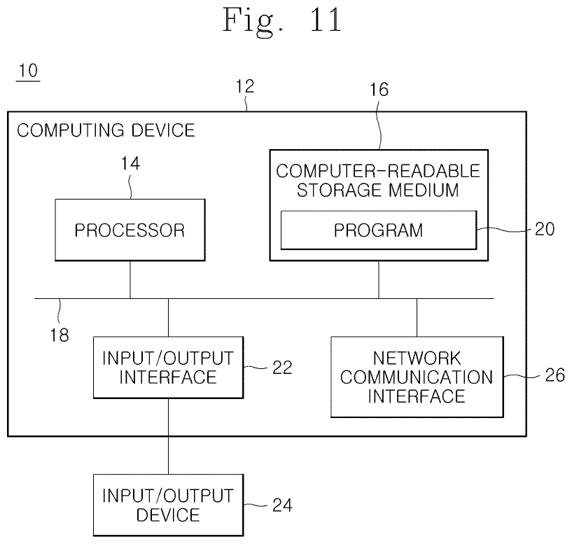

FIG. 11 is a block diagram illustrating a computing environment 10 suitable in illustrative embodiments. In the illustrated embodiments, the respective components may have different functions and capabilities, in addition to the description below, and an additional component that is not described below may be included.

The illustrated computing environment 10 includes a computing device 12. According to an embodiment, the computing device 12 may be the chat service server 100 that provides a chat service using a large language model according to an embodiment of the present disclosure.

The computing device 12 may include at least one processor 14, a computer-readable storage medium 16, and a communication bus 18. The processor 14 may enable the computing device 12 to operate according to the above-described embodiments. For example, the processor 14 may implement one or more programs stored in the computer-readable storage medium 16. The one or more programs may include one or more computer-executable instructions, and the computer-executable instructions may be configured to enable the computing device 12 to perform operations according to embodiments when the computer-executable instructions are executed by the processor 14.

The computer-readable storage medium 16 may be configured to store a computer-executable instruction or program code, program data, and/or other appropriate types of information. The program 20 stored in the computer-readable storage medium 16 may include a set of instructions executable by the processor 14. According to an embodiment, the computer-readable storage medium 16 may be memory (volatile memory such as random access memory, non-volatile memory, or an appropriate combination thereof), one or more magnetic disk storage devices, optical disc storage devices, flash memory devices, and other types of storage media accessed by the computing device 12 and capable of storing necessary information, or an appropriate combination thereof.

The communication bus 18 may mutually connect various components of the computing device 12, including the processor 14 and the computer-readable storage medium 16.

The computing device 12 may include one or more input/output interfaces 22 that provide interfaces for one or more input/output devices 24, and may include one or more network communication interfaces 26. The input/output interface 22 and the network communication interface 26 may be connected to the communication bus 18. The input/output device 24 may be connected to other components of the computing device 12 via the input/output interface 22. The illustrative input/output device 24 may include a pointing device (a mouse, a trackpad, or the like), a keyboard, a touch input device (a touch pad, a touch screen, or the like), a voice or sound input device, various types of sensor devices, and/or an input device such as a photographing device, and/or an output device such as a display device, a printer, a speaker, and/or a network card. The illustrative input/output device 24 may be included in the computing device 12 as one of the components that constitute the computing device 12, or may be connected to the computing device 12 as a separate device from the computing device 12.

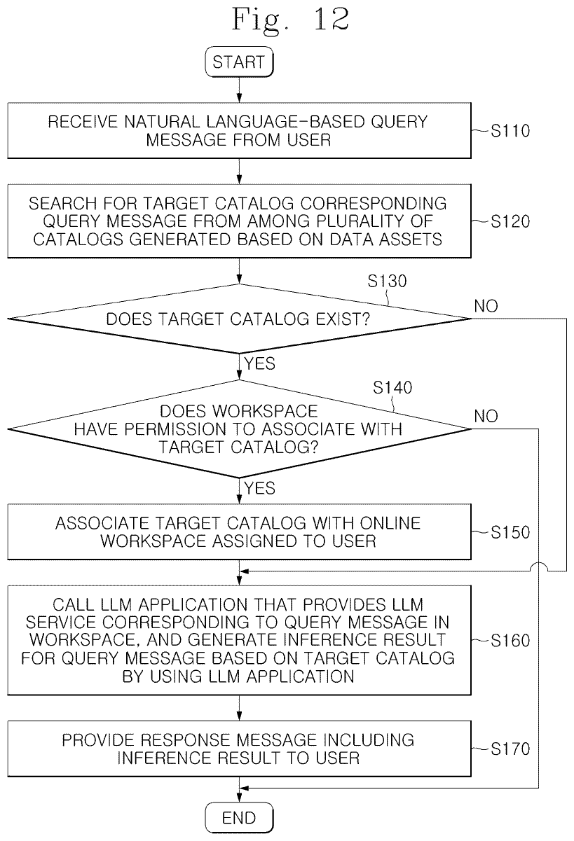

FIG. 12 is a flowchart illustrating a chat service provision method using an LLM according to an embodiment of the present disclosure. Here, each operation in FIG. 12 may be performed by a computing device according to an embodiment of the present disclosure.

Referring to FIG. 12, a computing device may receive a natural language-based query message from a user in operation S110. The user may input a necessary query message via a chat application or the like, and the query message may be input in the form of text, voice, or the like. In addition, various types of attached files such as images, voice, videos, program codes, or the like may be included in the query message and be transmitted together.

The computing device may search for a target catalog corresponding to the query message from among a plurality of catalogs generated based on data assets in operation S120. That is, when a query message is input, the computing device may search a catalog DB for the target catalog which is a basis for the generation of a response message for the corresponding query message.

Specifically, the computing device may receive user information associated with the corresponding user, or may extract query information included in the query message via natural language processing (NLP). Subsequently, based on the user information and query information, the computing device may search for corresponding target catalogs from among the plurality of catalogs, and may provide the retrieved target catalogs as a search result. User information may include contents associated with a department, position, assigned duty, or the like for each user, and query information may be an embedding vector extracted from a query message by using a neural network model or the like.

Subsequently, the computing device may identify whether the target catalog exists in operation S130, and, when the target catalog exists, may identify whether a workspace has permission to associate with the target catalog in operation S140. Specifically, based on workspace's permission information stored in a key management system (not illustrated) of a service server, the computing device may identify whether permission for the corresponding target catalog is included. Here, the permission information may be a pass ticket issued for each user or user group assigned to a workspace in response to a usage application for each catalog. The pass ticket may be issued by a producer that produces a catalog or an LLM application, or a separate permission management system (not illustrated).

That is, each user or user group may apply for the use of an individual catalog, and a pass ticket may be issued upon approval of each usage application. When a pass ticket is issued, a key management system may store the pass ticket as permission information for each workspace. When a workspace requests the association with a target catalog, the permission of the corresponding workspace may be identified based on the pass tickets stored in the key management system. Subsequently, based on a result of permission identification, whether to associate the target catalog and the corresponding workspace may be determined.

According to an embodiment, when permission for the corresponding target catalog does not exist in the workspace, the computing device may display, to the user, a popup message or the like to identify whether the user is to request usage approval. That is, based on an input that the user applies to the popup message, the computing device may receive a usage approval request associated with a target catalog. Subsequently, the computing device may transmit the usage approval request to a permission management system (not illustrated) or the like, and may request issuing a pass ticket for the corresponding workspace.

Subsequently, the computing device may associate the target catalog with the online workspace assigned to the user in operation S150. That is, the computing device may associate the retrieved target catalog with the workspace of the corresponding user, so that the user is capable of performing a task based on the target catalog on the corresponding workspace.

According to an embodiment, the computing device may provide a catalog list including a plurality of target catalogs as a search result, and the user may select any one target catalog from the catalog list. In this instance, the computing device may associate the target catalog selected by the user with the workspace. In this instance, the computing device may perform the association in a manner of converting the target catalog into a predetermined meta language such as JSON or the like and providing the same to the workspace, or the like.

According to an embodiment, although a query message is not input yet, the computing device may associate a target catalog with a corresponding user's workspace in response to a request from the user. That is, the user may search for a catalog corresponding to a task to perform before working on the task, and may request the association of the retrieved target catalog with the user's workspace. In this instance, the computing device may perform searching and provide a list of retrieved catalogs in response to the request from the user, and may associate, with the workspace of the corresponding user, the target catalog selected by the user from the list. In addition, there may be an embodiment where the computing device provides a list of recommended catalogs before the user performs searching, and the user selects a target catalog from the corresponding recommended list, or the like.

In addition, the computing device may call an LLM application that provides an LLM service corresponding to the query message in the workspace, and may generate an inference result for the query message based on the target catalog by using the LLM application in operation S160.

Specifically, the computing device may call the corresponding LLM application by using a predetermined chat API, and may transfer the target catalog, converted into a meta language of the workspace, to the called target LLM application by using the chat API. That is, the LLM application may generate a corresponding inference result based on the corresponding catalog.

Here, LLM services may include a natural language conversation service, a knowledge-based conversation service, a data analysis service, an API integration service, or the like. The natural language conversation service may be a service that provides a casual natural language conversation, generating, as an inference result, a response to a query by taking into account a multi-turn conversation history. The knowledge-based conversation (RAG) service may search for information based on a knowledge catalog selected by a user, and may generate a response including the retrieved information as an inference result. The data analysis service may analyze data based on a data catalog selected by a user. For example, the service may generate and execute a program for data analysis by using Python code or the like, may generate an analysis result graph or the like, and may provide the same as an inference result. The API integration service may execute an AIP based on a connector catalog selected by a user, and may provide an execution result associated with the corresponding API as an inference result.

Here, each LLM application may be added to a chat service in the form of a plug-in, and the LLM services provided by the chat service may be extended by further including an LLM application capable of being called using a plug-in. According to an embodiment, the natural language conversation service, knowledge-based conversation service, and data analysis service may be connected to the chat service by default for provision, and other remaining LLM applications may be added using plug-ins.

Each LLM application may call an LLM model and request inference according to a flow defined therein, may receive an inference result from the LLM model, and may provide the same to the computing device. Here, examples of the LLM model may include Llama, OpenBuddy, Azure OpenAI, or the like, and various other LLM models may be utilized. In addition, here, it is not that only a single LLM model is used, but a different LLM model may be used for each LLM application to generate an inference result.

Subsequently, the computing device may provide a response message including the inference result to the user in operation S170. That is, the computing device may generate a natural language-based response message, and the response message may be generated in the form of text, voice, or the like. In addition, the computing device may refine text included in the response message for enhanced visibility for the user, and may write and include html, a table, a chart, or the like indicating an inference result in the response message. In this instance, the response message may be displayed in a dialog window of a chat application (not illustrated) into which the user inputs a query message.

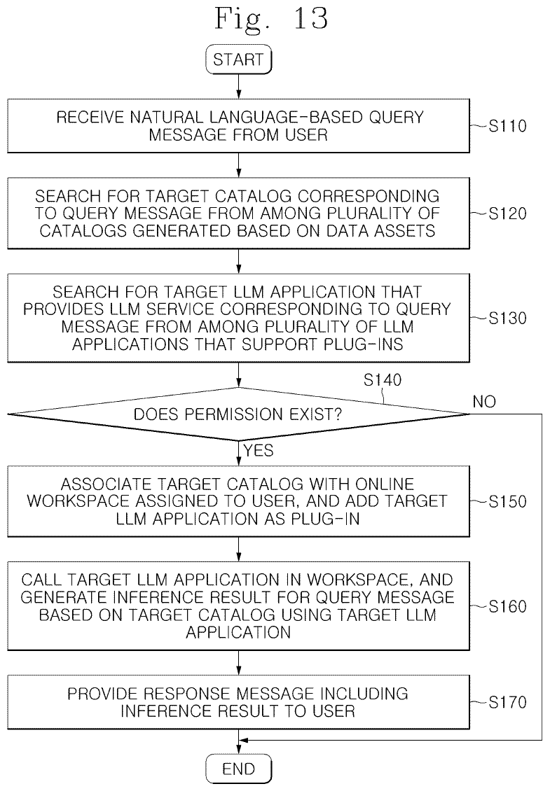

FIG. 13 is a flowchart illustrating a chat service provision method using an LLM according to another embodiment of the present disclosure. Here, each operation in FIG. 13 may be performed by a computing device according to an embodiment of the present disclosure.

Referring to FIG. 13, a computing device may receive a natural language-based query message from a user in operation S110. The user may input a necessary query message via a chat application or the like, and the query message may be input in the form of text, voice, or the like. In addition, various types of attached files such as images, voice, videos, program codes, or the like may be included in the query message and be transmitted together.

Subsequently, the computing device may search for a target catalog corresponding to the query message from among a plurality of catalogs generated based on data assets in operation S120. That is, when a query message is input, the computing device may search a catalog DB for the target catalog which is a basis for the generation of a response message for the corresponding query message.

Specifically, the computing device may receive user information associated with the corresponding user, or may extract query information included in the query message via natural language processing (NLP). Subsequently, based on the user information and query information, the computing device may search for corresponding target catalogs from among the plurality of catalogs, and may provide the retrieved target catalogs as a search result. User information may include contents associated with a department, position, assigned duty, or the like for each user, and query information may be an embedding vector extracted from a query message by using a neural network model or the like.

Subsequently, the computing device may search for a target LLM application that provides an LLM service corresponding to the query message from among a plurality of LLM applications that support plug-ins, in operation S130. That is, when the query message is input, the computing device may search an LLM service server for an LLM application to be used for generating a response message for the corresponding query message. According to an embodiment, an LLM application may be generated as a catalog. In this instance, each LLM application may be retrieved from catalogs. Here, the computing device may search for each target LLM application based on user information and query information.

Subsequently, the computing device may identify whether a workspace has permissions for the target catalog and the target LLM application in operation S140. Specifically, based on workspace's permission information stored in a key management system (not illustrated) of a service server, the computing device may identify whether the permissions for the corresponding target catalog and the target LLM application are included. Here, the permission information may be a pass ticket (passticket) issued for each user or user group assigned to a workspace in response to a usage application for each catalog. The pass ticket may be issued by a producer that produces a catalog or an LLM application, or by a separate permission management system (not illustrated).

That is, each user or user group may apply for the use of an individual catalog or an LLM application, and a pass ticket may be issued upon approval of each usage application. When a pass ticket is issued, the key management system may store the pass ticket as permission information for each workspace. When a workspace requests the association with a target catalog or the plug-in of a target LLM application, the permission of the corresponding workspace may be identified based on the pass tickets stored in the key management system. Subsequently, based on a result of permission identification, whether to associate the target catalog and the corresponding workspace and whether to plug in the target LLM application may be determined.

When permission for the corresponding target catalog or the target LLM application does not exist in the workspace, the computing device may display, to the user, a popup message or the like to identify whether the user is to request usage approval according to an embodiment. That is, based on an input that the user applies to the popup message, the computing device may receive a usage approval request associated with the target catalog or the target LLM application. Subsequently, the computing device may transmit the usage approval request to a permission management system (not illustrated) or the like, and may request issuing a pass ticket for the corresponding workspace.

Subsequently, the computing device may associate the target catalog with the online workspace assigned to the user, and may add the target LLM application as a plug-in in operation S150. That is, the computing device may associate the retrieved target catalog with the workspace of the corresponding user and may plug in the target LLM application to a chat service, so that the user is capable of performing a task based on the target catalog on the corresponding workspace.

According to an embodiment, the computing device may provide a catalog list including a plurality of target catalogs as a search result, and the user may select any one target catalog from the catalog list. In this instance, the computing device may associate the target catalog selected by the user with the workspace. In this instance, the computing device may perform the association in a manner of converting the target catalog into a predetermined meta language such as JSON or the like and providing the same to the workspace, or the like.

According to an embodiment, although a query message is not input yet, the computing device may associate a target catalog with a corresponding user's workspace in response to a request from the user. That is, the user may search for a catalog corresponding to a task to perform before working on the task, and may request the association of the retrieved target catalog with the user's workspace. In this instance, the computing device may perform searching and provide a list of retrieved catalogs in response to the request from the user, and may associate, with the workspace of the corresponding user, the target catalog selected by the user from the list. In addition, there may be an embodiment where the computing device provides a list of recommended catalogs before the user performs searching, and the user selects a target catalog from the corresponding recommended list, or the like.

In the same manner, according to an embodiment, the computing device may provide an application list including a plurality of target LLM applications as a search result, and the user may select any one target LLM application from the application list. In this instance, the computing device may plug in the target LLM application, selected by the user, to a chat service.

In addition, according to an embodiment, although a query message is not input yet, the computing device may plug in an LLM application to a chat service in response to a request from the user. That is, the user may search for LLM applications corresponding to a task to perform before working on the task, and may request plugging in a retrieved target LLM application. In this instance, the computing device may perform searching and provide a list of retrieved LLM applications in response to the request from the user, and may plug in a target LLM application selected by the user from the list. In addition, there may be an embodiment where the computing device provides a list of recommended applications before the user performs searching, and the user selects a target LLM application from the corresponding recommended list.

In addition, the computing device may call a target LLM application in the workspace, and may generate an inference result for the query message based on the target catalog by using the target LIM application in operation S160.

Specifically, the computing device may call the corresponding target LLM application by using a predetermined chat API, and may transfer the target catalog, converted into a meta language of the workspace, to the called target LLM application by using the chat API. That is, the target LLM application may generate a corresponding inference result based on the corresponding target catalog.

Here, LLM services may include a natural language conversation service, a knowledge-based conversation service, a data analysis service, an API integration service, or the like. Target LLM applications may be added to a chat service in the form of a plug-in, and the LLM services provided by the chat service may be extended by further including an LLM application capable of being called using a plug-in. According to an embodiment, the natural language conversation service, knowledge-based conversation service, and data analysis service may be connected to the chat service by default for provision, and other remaining LLM applications may be added using plug-ins.

Each LLM application may call an LLM model and request inference according to a flow defined therein, may receive an inference result from the LLM model, and may provide the same to the computing device. Here, examples of the LLM model may include Llama, OpenBuddy, Azure OpenAI, or the like, and various other LLM models may be utilized. In addition, here, it is not that only a single LLM model is used, but a different LLM mode may be used for each LLM application to generate an inference result.

Subsequently, the computing device may provide a response message including the inference result to the user in operation S170. That is, the computing device may generate a natural language-based response message, and the response message may be generated in the form of text, voice, or the like. In addition, the computing device may refine text included in the response message for enhanced visibility for the user, and may write and include html, a table, a chart, or the like indicating an inference result in the response message. In this instance, the response message may be displayed in a dialog window of a chat application (not illustrated) into which the user inputs a query message.

The above-described present disclosure may be implemented as computer-readable code in a medium in which a program is recorded. The computer-readable medium may continuously store a computer-executable program, or may temporarily store the same for execution or downloading. In addition, the medium may be one of the various types of recording devices or storage devices provided in a single entity or in a form in which a plurality of pieces of hardware are combined, and the medium is not limited to a medium that is directly connected to a predetermined computer system and may be distributed in a network. The examples of the medium may include a magnetic medium such as hard disk, floppy disk, and magnetic tape, an optical recording medium such as CD-ROM and DVD, and magneto-optical medium such as a floptical disk, and a medium including ROM, RAM, flash memory, and the like to store program instructions. In addition, examples of another medium may include a recording medium or a storage medium managed by an app store that distributes applications, a site that supplies or distributes various types of software, a server, or the like. Therefore, the detailed description should not be construed restrictively in all aspects, but should be considered as examples. The scope of the present disclosure should be determined by rational interpretation of attached claims, and all modifications made in the scope equivalent to that of the present disclosure should be included in the scope of the present disclosure.

The present disclosure is not limited by the above-described embodiments and attached drawings. It is apparent to those skilled in the art field to which the present disclosure belongs that the components of the present disclosure are capable of being replaced, modified, and changed within a scope without departing from the technical idea of the present disclosure.

What is claimed is:

1. A method of providing a chat service of a chat service server that uses a large language model (LLM), the method comprising:
receiving a natural language-based query message from a user;
searching for a target catalog corresponding to the query message from among a plurality of catalogs generated based on data assets;
associating the target catalog with an online workspace assigned to the user;
calling an LLM application that provides an LIM service corresponding to the query message in the workspace, and generating an inference result for the query message based on the target catalog by using the LLM application; and
providing a response message including the inference result to the user.

2. The method of claim 1, wherein the catalog is generated from entire data assets including at least one of a document, content, an application programmable interface (API), a file, and program code generated in a predetermined group, and is a unit of an information set shared, distributed, or used in the predetermined group.

3. The method of claim 1, wherein the searching comprises providing, as a search result, a corresponding target catalog from among the plurality of catalogs by using user information associated with the user and query information extracted by performing natural language processing on the query message.

4. The method of claim 1, wherein the associating comprises providing a catalog list including a plurality of target catalogs as a search result, and associating, with the workspace, a target catalog selected by the user from the catalog list.

5. The method of claim 1, wherein the chat service server adds the LLM application capable of being called using a plug-in, and extends providable LLM services.

6. The method of claim 1, further comprising identifying whether the workspace has permission to associate with the target catalog when the target catalog is retrieved.

7. The method of claim 6, wherein the identifying comprises determining whether the target catalog is included in the workspace's permission information stored in a key management system.

8. The method of claim 7, wherein the permission information includes a pass ticket (passticket) which is issued for each user or user group, assigned to the workspace, in response to a usage application for each catalog.

9. The method of claim 6, wherein the identifying comprises, if the workspace does not have the permission, receiving a usage approval request for the target catalog from the user.

10. The method of claim 1, further comprising, if the user selects a target catalog from a catalog list including a plurality of catalogs before the query message is received, associating the target catalog with the workspace of the user.

11. A chat service server comprising a processor, and providing a chat service using a large language model (LLM), wherein the processor is configured to:
receive a natural language-based query message from a user;
search for a target catalog corresponding to the query message from among a plurality of catalogs generated based on data assets;
associate the target catalog with an online workspace assigned to the user;
call an LLM application that provides an LLM service corresponding to the query message in the workspace, and generate an inference result for the query message based on the target catalog by using the LLM application; and
provide a response message including the inference result to the user.

12. A method of providing a chat service of a chat service server that uses a large language model (LLM), the method comprising:
receiving a natural language-based query message from a user;
searching for a target catalog corresponding to the query message from among a plurality of catalogs generated based on data assets;
searching for a target LLM application that provides an LLM service corresponding to the query message from among a plurality of LLM applications that support plug-ins;
associating the target catalog with an online workspace assigned to the user, and adding the target LLM application as a plug-in;
calling the target LLM application in the workspace, and generating an inference result for the query message based on the target catalog by using the target LLM application; and
providing a response message including the inference result to the user.

13. The method of claim 12, wherein the LIM application is generated to provide a corresponding LLM service by combining an LLM model and a predetermined pattern.

14. The method of claim 13, wherein the LLM application is implemented by generating a meta language that represents a pattern and a logic for providing the LIM service in a GUI-based workflow form, and generating program code based on the meta language.

15. The method of claim 12, wherein the searching for the target LLM application comprises providing the corresponding target LIM application from among the plurality of LLM applications by using user information associated with the user and query information extracted by performing natural language processing on the query message.

16. The method of claim 12, further comprising, if the user selects a target LLM application from a plug-in list including a plurality of LLM applications before the query message is received, adding the target LIM application as a plug-in.

17. The method of claim 12, further comprising, if the target catalog and the target LIM application are retrieved, identifying whether the workspace has permissions for the target catalog and the target LIM application.

18. The method of claim 17, wherein the identifying comprises determining whether the target catalog and the target LIM application are included in the workspace's permission information stored in a key management system.

19. The method of claim 18, wherein the permission information includes a pass ticket (passticket) which is issued for each user or user group, assigned to the workspace, in response to a usage application for each catalog and each LLM application.

20. The method of claim 17, wherein the identifying comprises, if the workspace does not have the permission, receiving a usage approval request for the target catalog or the target LLM application from the user.
